(19) United States
(12) Patent Application Publication
(10) Pub. No.: US 2025/0264678 A1
(43) Pub. Date: Aug. 21, 2025

(54) CABLE JACKET DESIGNS FOR HIGH DENSITY OPTICAL FIBER CABLES

(71) Applicant: CORNING RESEARCH & DEVELOPMENT CORPORATION, Corning, NY (US)

(72) Inventors: Xiaole Cheng, Painted Post, NY (US); Sergey Vladimirovich Chernykh, Berlin (DE); Kenneth Darrell Temple, Jr., Newton, NC (US)

(21) Appl. No.: 19/202,434

(22) Filed: May 8, 2025

Related U.S. Application Data
(63) Continuation of application No. PCT/US2023/079750, filed on Nov. 15, 2023.
(60) Provisional application No. 63/426,107, filed on Nov. 17, 2022.

(51) Int. Cl. G02B 6/44

(52) U.S. Cl. CPC G02B 6/443

(57) ABSTRACT

Embodiments of the disclosure relate to an optical fiber cable. The optical fiber cable includes a cable jacket having an inner surface and an outer surface. The inner surface defines a central bore, and the outer surface defines an outermost surface of the optical fiber cable. The optical fiber cable also includes a cable core disposed in the central bore, and the cable core includes a plurality of optical fibers. The optical fiber cable has a cross-sectional area as defined by the outer surface of the cable jacket. The plurality of optical fibers divided by the cross-sectional area defines a fiber density of at least 7.5 fibers/mm². The cable jacket has a first layer, and the first layer is made of an engineering thermoplastic having an elastic modulus of at least 800 MPa.

### CROSS-REFERENCE TO RELATED APPLICATIONS

This application is a continuation of International Patent Application No. PCT/US2023/079750, filed Nov. 15, 2023, which claims the benefit of priority of U.S. Provisional Application No. 63/426,107 filed on Nov. 17, 2022, the content of which is relied upon and incorporated herein by reference in its entirety.

### BACKGROUND

The disclosure relates generally to optical fiber cables and, in particular, to cable jacket designs for optical fiber cables having a high density of optical fibers.

In general, an optical fiber cable needs to carry more optical fibers in order to transmit more optical data, and in order to carry more optical fibers, the size of the optical fiber cable conventionally needed to be increased. The increased size is at least partially the result of free space considerations to avoid macro- and micro-bending attenuation losses. For existing installations, size limitations and duct congestion limit the size of optical fiber cables that can be used without the requirement for significant retrofitting. Thus, it may be desirable to provide optical fiber cables having a higher fiber density (i.e., more fibers per cross-sectional area of the cable) without increasing the cable diameter such that the high fiber density cables can be used in existing ducts.

### SUMMARY

According to an aspect, embodiments of the disclosure relate to an optical fiber cable. The optical fiber cable includes a cable jacket having an inner surface and an outer surface. The inner surface defines a central bore, and the outer surface defines an outermost surface of the optical fiber cable. The optical fiber cable also includes a cable core disposed in the central bore, and the cable core includes a plurality of optical fibers. The optical fiber cable has a cross-sectional area as defined by the outer surface of the cable jacket. The plurality of optical fibers divided by the cross-sectional area defines a fiber density of at least 7.5 fibers/mm². The cable jacket has a first layer, and the first layer is made of an engineering thermoplastic having an elastic modulus of at least 800 MPa.

According to another aspect, embodiments of the disclosure relate to a high fiber density optical fiber cable. The optical fiber cable includes a cable jacket having an inner surface and an outer surface. The inner surface defines a central bore, and the outer surface defines an outermost surface of the optical fiber cable. A cable core is disposed in the central bore, and the cable core includes a plurality of optical fibers. The optical fiber cable has a cumulative fiber filling coefficient of at least 50%. The cable jacket has at least two layers, and the at least two layers are selected from a group consisting of a skin layer, an engineering thermoplastic layer, and a thermoplastic elastomer layer.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments. In the drawings:

FIG. 1 depicts a cross-sectional view of an optical fiber cable having optical fibers arranged in a plurality of lumens, according to an exemplary embodiment;

FIG. 2 depicts a cross-sectional view of an optical fiber cable having optical fibers arranged in a plurality of intermittently bonded ribbons, according to an exemplary embodiment;

FIG. 3 depicts a cross-sectional view of an optical fiber cable having a cable jacket made of an engineering thermoplastic, according to an exemplary embodiment;

FIG. 4 depicts a cross-sectional view of an optical fiber cable having a cable jacket with two layers, an engineering thermoplastic layer and a thermoplastic elastomer layer, according to an exemplary embodiment;

FIG. 5 depicts a cross-sectional view of an optical fiber cable having a cable jacket with a discontinuous inner layer, according to an exemplary embodiment;

FIG. 6 depicts a cross-sectional view of an optical fiber cable specimen prepared for thermal cycling testing, according to an exemplary embodiment; and

FIG. 7 depicts the results of the thermal cycling test, according to exemplary embodiments.

### DETAILED DESCRIPTION

Referring generally to the figures, various embodiments of cable jacket designs for a high fiber density optical fiber cable are provided. As will be discussed more fully below, embodiments of the cable jacket designs include at least one layer of an engineering thermoplastic configured to increase the bending stiffness of the optical fiber cable and improve the anti-buckling performance at low temperatures. In one or more embodiments discussed below, the cable jacket also includes a thermoplastic elastomer layer that can be foamed or unfoamed. The thermoplastic elastomer helps, in particular, with improving the anti-buckling performance of the optical fiber cable at low temperatures. In one or more embodiments discussed below, the cable jacket also includes a skin layer configured to provide environmental protection of the optical fiber cable or reduce friction for blowing or jetting operations. The exemplary embodiments of such cable jacket designs for a high fiber density optical fiber cable will be described in greater detail below and in relation to the figures provided herewith, and these exemplary embodiments are provided by way of illustration, and not by way of limitation.

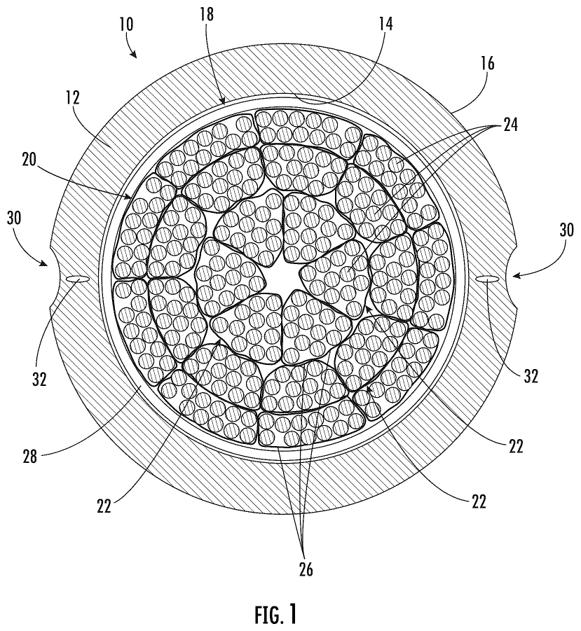

FIG. 1 depicts an example embodiment of a high fiber density optical fiber cable 10. The optical fiber cable 10 includes a cable jacket 12 having an inner surface 14 and an outer surface 16. The inner surface 14 of the optical fiber cable 10 defines a central bore 18 that extends along a longitudinal axis of the optical fiber cable 10. Disposed within the central bore 18 of the optical fiber cable 10 is high fiber density cable core 20. In the embodiment shown in FIG. 1, the high fiber density cable core 20 includes a plurality of subunits referred to herein as “lumens” 22. The lumens 22 each include a plurality of optical fibers 24 surrounded by a membrane 26. The membrane 26 is a thin and flexible sheath that allows for the lumen 22 to be reconfigured into a variety of different shapes. In this way, the lumens 22 can be densely packed within the cable core 20 by changing shape, e.g., flattening out, bunching up, or bending, as necessary to fill space within the cable core 20.

In one or more embodiments, the interior surface of the membrane 26 defines an interior cross-sectional area of the lumen 22. The portion of this interior cross-sectional area that is not occupied by the optical fibers 24 is referred to as “free space.” In one or more embodiments, each lumen 22 comprises a free space of 50% or less, 40% or less, 30% or less, or 25% or less. In one or more embodiments, each lumen 22 comprises a free space of 20% or more. Not only does the low free space within the lumens 22 provide a high fiber density for the optical fiber cable 10, but also, the low free space mechanically couples the optical fibers 24 together such that the optical fibers 24 may act as a composite strength element within the optical fiber cable 10. In this way, and in accordance with aspects of the present disclosure, the cable core 20 may be configured to not include any additional strength elements, such as glass reinforced plastic rods, steel wires, or tensile strands (e.g., aramid or glass yarns).

In one or more embodiments, the thickness of the membrane 26 is 50 μm or less, 45 μm or less, 40 μm or less, 35 μm or less, 30 μm or less, 25 μm or less, 20 μm or less, 17 μm or less, or 15 μm or less. In one or more embodiments, the thickness of the membrane 26 is 5 μm or more, 6 μm or more, 7 μm or more, 8 μm or more, 9 μm or more, or 10 μm or more. In one or more embodiments, the thickness of the membrane 26 is from 5 μm to 50 μm, in particular from 7 μm to 30 μm, and most particularly from 10 μm to 20 μm.

In one or more embodiments, the membrane 26 groups from two to ninety-six in particular from eight to thirty-six, and particularly from twelve to twenty-four, optical fibers 24 into a lumen 22. In one or more embodiments, the membrane 26 is formed from a polymer material, such as a polyethylene, a polypropylene, a polyester (e.g., polyethylene terephthalate or polybutylene terephthalate), a polystyrene, a polycarbonate, a polyamide, a polytetrafluoroethylene, or copolymers or blends thereof. In one or more embodiments, the membrane 26 includes a filler material dispersed in the polymer material to enhance the ability of the membrane 26 to be torn by an operator's fingers (i.e., without requiring any specialized tools) in a manner that does not damage the optical fibers 24 contained therein.

In one or more embodiments, the lumens 22 may be stranded (such as SZ-stranded) in the cable core 20. The stranding provides the ability to bend the cable while minimizing tensile and contractive forces within any of the fibers. During cable bending, the optical fibers 24 must be able to shift position, moving longitudinally to relieve those forces so as not to cause attenuation or break the optical fibers 24. Because the membranes 26 and cable core 20 do not provide free space for the optical fibers 24 to increase fiber density by design, the lumens 22 may be configured to move relative to each other in certain embodiments by using solid or gel lubricants, such as talc, or using water-absorbing powders.

In one or more embodiments, the high fiber density cable core 20 is surrounded by a binder 28. In one or more embodiments, the binder 28 is a thin film jacket having a thickness between 40 microns and 150 microns. In such embodiments, the binder 28 having a thickness in this thickness range reduces the thermal load of the binder 28 on the lumens 22 during extrusion. That is, a thick binder could hold enough heat after extrusion to degrade the thin membranes 26 of the lumens 22. In one or more embodiments, the binder 28 is made from, e.g., linear low-density polyethylene (LLDPE). In one or more other embodiments, the binder 28 is a wrap or tape that is wound around the cable core 20.

In one or more embodiments, the cable jacket 12 has a thickness of between 0.5 mm and 2 mm. In particular embodiments, the cable jacket 12 has a thickness that is from 8% to 10% of the outer diameter of the optical fiber cable 10.

In one or more embodiments, the cable jacket 12 includes tactile locator features 30. In the embodiment depicted, the tactile locator features 30 comprise diametrically arranged depressions defined by the outer surface 16 of the cable jacket 12. However, in one or more other embodiments, the tactile locator features 30 comprise diametrically arranged bumps defined by the outer surface 16 of the cable jacket 12. The tactile locator features 30 assist a user in opening the cable 10 by guiding the user to the location of access features 32. In the embodiment of the optical fiber cable 10, the access features 32 are strips of dissimilar polymer embedded in the polymer of the cable jacket 12. For example, the cable jacket 12 may substantially comprise polyethylene, and the dissimilar polymer of the access feature 32 may be polypropylene. The immiscibility of polyethylene in the cable jacket 12 and the polypropylene of the access features 32 prevents a strong bond from forming between the cable jacket 12 and the access features 32, allowing for a user to tear through the cable jacket 12 in the region of the access features 32. Further, once opened at the access features 32, the cable jacket 12 can be split along its length along the access features 32.

In one or more embodiments, the optical fiber cable 10 may consist essentially of the cable jacket 12 surrounding a plurality of lumens 22. Other components that do not affect the basic and novel characteristics of the optical fiber cable 10 that may be included are, for example, a binder 28 provided between the plurality of lumens 22 and the cable jacket 12, water blocking material (e.g., tapes and powders), lubricants, friction-enhancing materials, and access features 32 (e.g., ripcords or preferential tear features, such as a strip of dissimilar polymer in the cable jacket 12). In one or more embodiments, armor layers and strength elements are excluded from the construction of the optical fiber cable 10.

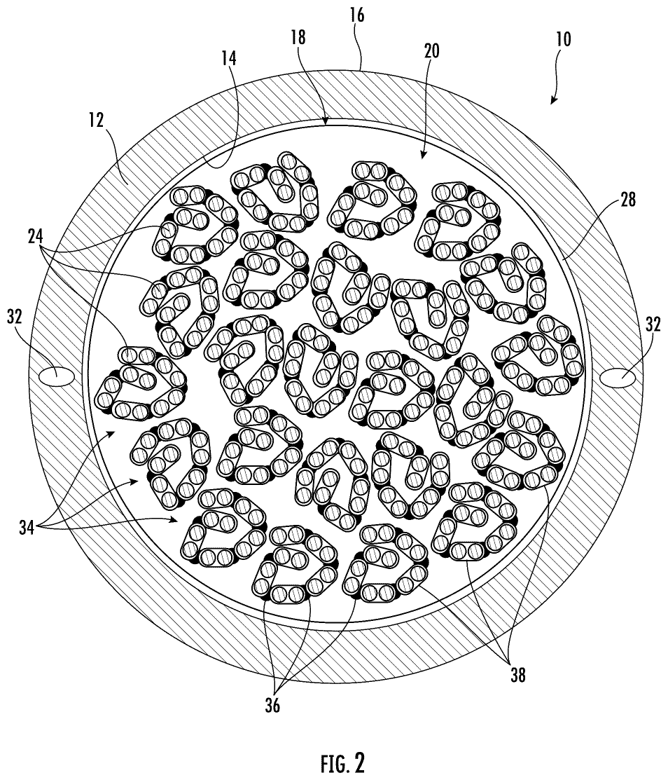

FIG. 2 depicts another example embodiment of a high-density optical fiber cable 10. The optical fiber cable 10 includes a cable jacket 12 having an inner surface 14 and an outer surface 16. The inner surface 14 of the optical fiber cable 10 defines a central bore 18 that extends along a longitudinal axis of the optical fiber cable 10. Disposed within the central bore 18 of the optical fiber cable 10 is high fiber density cable core 20. In one or more embodiments, including the embodiment depicted in FIG. 2, the high fiber density cable core 20 includes a plurality of intermittently bonded optical fiber ribbons 34. In one or more embodiments, each optical fiber ribbon 34 includes from four to thirty-six optical fibers 24, in particular eight to twenty-four optical fibers 24, and particularly about twelve optical fibers 24.

The optical fiber ribbons 34 include optical fibers 24 that are joined by intermittent bonds 36. In one or more embodiments, the individual optical fibers 24 are intermittently bonded together. In one or more other embodiments, including the embodiment shown in FIG. 2, the optical fibers 24 are arranged in subunits 38 of two or more optical fibers 24 that are joined by intermittent bonds 36. The intermittent bonding between the optical fibers 24 or the subunits 38 of optical fibers 24 allows the optical fiber ribbon 34 to roll, fold, collapse, or otherwise transition from a planar configuration to a non-planar configuration. Advantageously, the non-planar configuration of the optical fiber ribbon 34 permits the optical fiber ribbons 34 to be more densely packed into the cable core 20. In contrast, conventional optical fiber ribbons that are held rigidly in the planar configuration require a greater amount of free space within the cable core to accommodate the ribbon stack without creating stress on the edge fibers.

In one or more embodiments, the high fiber density cable core 20 is surrounded by a binder 28 as described above.

In one or more embodiments, the optical fiber cable 10 includes a cable jacket 12 having one or more tactile locator features 30 (not shown in FIG. 2) as described above. Additionally, in one or more embodiments, the cable jacket 12 may include one or more access features 32, such as strips of dissimilar polymer embedded in the polymer of the cable jacket 12.

In one or more embodiments, the optical fiber cable 10 may consist essentially of the cable jacket 12 surrounding a plurality of intermittently bonded optical fiber ribbons 34. Other components that do not affect the basic and novel characteristics of the optical fiber cable 10 that may be included are, for example, a binder 28 provided between the plurality of optical fiber ribbons 34 and the cable jacket 12, water blocking material (e.g., tapes and powders), lubricants, friction-enhancing materials, and access features 32 (e.g., ripcords or preferential tear features, such as a strip of dissimilar polymer in the cable jacket 12). In one or more embodiments, armor layers and strength elements are excluded from the construction of the optical fiber cable 10.

In one or more embodiments, the optical fiber cable 10 includes from 12 to 3456 optical fibers 24, more particularly from 48 to 864 optical fibers 24, or still more particularly from 96 to 576 optical fibers 24. In one or more embodiments, the optical fiber cable 10 has a fiber density of at least 7.5 fibers/mm². The fiber density is measured based on the number of optical fibers 24 per cross-sectional area of the optical fiber cable 10 as measured from the outer surface 16. In one or more embodiments, the fiber density is at least 8 fibers/mm², at least 8.5 fibers/mm², at least 9 fibers/mm², at least 9.5 fibers/mm², at least 10 fibers/mm², at least 10.5 fibers/mm², at least 11 fibers/mm², at least 11.5 fibers/mm², or at least 12 fibers/mm². In one or more embodiments, the fiber density may be up to 17 fibers/mm².

In one or more embodiments, the outer diameter of the optical fiber cable 10 as measured at the outer surface 16 is 9 mm or less, 8.5 mm or less, 8 mm or less, 7.5 mm or less, 7 mm or less, 6.75 mm or less, 6.5 mm or less, 6.25 mm or less, 6 mm or less, 5.75 mm or less, 5.5 mm or less, 5.25 mm or less, or 5 mm or less. Further, in one or more embodiments, the outer diameter of the optical fiber cable 10 as measured from the outer surface 16 is at least 2 mm.

In one or more embodiments, the optical fiber cable 10 has a cumulative fiber filling coefficient of at least 50%, at least 60%, at least 65%, or at least 70%. In one or more embodiments, the optical fiber cable 10 has a cumulative fiber filling coefficient of up to 85%. As used herein, the term “cumulative fiber filling coefficient” of an optical-fiber cable 10 refers to the ratio of (1) the sum of the cross-sectional areas of all of the optical fibers 24 within the optical-fiber cable 10 to (2) the inner cross-sectional area of the optical-fiber cable 10 (i.e., defined by the inner surface 14 of the cable jacket 12 or inner surface of binder 28, if included). The cross-sectional area of each optical fiber 24 is determined based on an outer surface of the optical fiber 24.

In one or more embodiments, the optical fiber cable 10 comprises a free space of at most 50%, at most 42.5%, at most 30%, or at most 25%. In one or more embodiments, the free space of the optical fiber cable 10 is at least 15%. As used herein, the free space is the inverse of cumulative fiber filling coefficient (i.e., 100%-cumulative fiber filling coefficient).

The high fiber density optical fiber cables 10 as described herein are beneficial for reducing cable diameter and duct size or for increasing fiber count within an existing duct. While the optical fibers may provide sufficient tensile strength for the optical fiber cable 10, allowing for the avoidance of dedicated strength elements, the optical fiber cables 10 may not have sufficient stiffness for blowing applications and anti-buckling performance at low temperatures. In order to address these challenges, embodiments of the present disclosure relate to cable jacket designs configured to enhance the cable stiffness and improve the anti-buckling performance at low temperatures. In one or more embodiments, the bending stiffness of the cable is at least 0.1 N·m², in particular up to 0.15 N·m² or even 0.2 N·m². As will be discussed more fully below, the goal of improving cable bending stiffness typically is counter to the goal of improving anti-buckling performance at low temperatures, and the inventors surprisingly and unexpectedly were able to capture improvements to both aspects through the disclosed cable jacket designs.

As mentioned above, cable blowing or jetting performance is largely based on cable bending stiffness, and the bending stiffness is proportional to the elastic modulus of the optical fiber cable. Conventionally, the elastic modulus of the cable is increased by incorporating strength elements, such as fiber-reinforced plastic rods. Absent incorporating such elements to enhance the fiber density of the cable, the primary mechanism of increasing the elastic modulus of the optical fiber cable is to increase the elastic modulus of the cable jacket.

At low temperatures, the cable jacket contracts (or buckles), creating contraction stress on the optical fibers in the optical fiber cable. The contraction stress is related to the elastic modulus and to the coefficient of thermal expansion (CTE). Thus, to reduce contraction stress, it is typically desirable to use a low modulus and low CTE material for the cable jacket. However, using a lower modulus material runs counter to the goal of increasing cable stiffness.

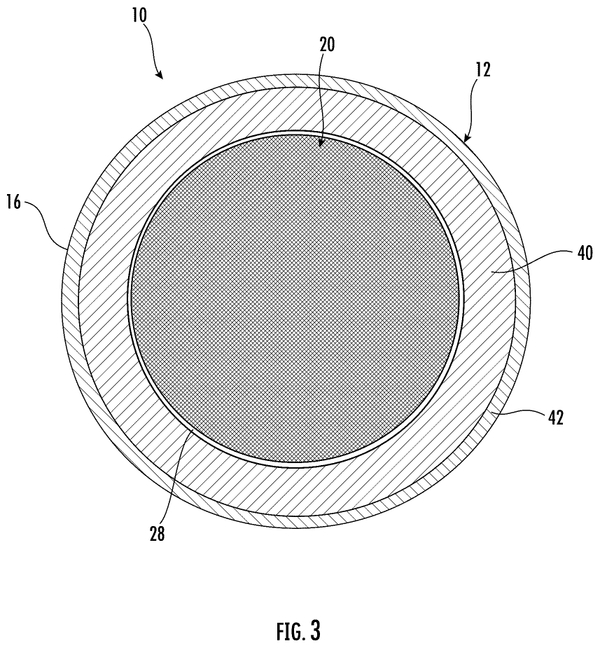

Nevertheless, the inventors identified particular materials and cable designs that provide not only high modulus by also low contraction stress at low temperatures. FIG. 3 depicts a first concept for a cable jacket 12. In FIG. 3, the cable jacket 12 surrounds a high density cable core 20, such as a lumen 22 cable core 20 as shown in FIG. 1 or intermittently bonded optical fiber ribbons 34 as shown in FIG. 2. In one or more embodiments, the cable jacket 12 includes a first layer 40 comprising an engineering thermoplastic. In one or more embodiments, the engineering thermoplastic has an elastic modulus of at least 800 MPa, in particular at least 1000 MPa, still more particularly 1200 MPa, and yet more particularly 1500 MPa. In one or more embodiments, the engineering thermoplastic has an averaged CTE (measured from −40° C. to 25° C.) of at most 150 ppm/° C., in particular at most 100 ppm/° C. . . . In one or more embodiments, the engineering thermoplastic has a strain at break of at least 100% at 23° C., in particular at least 200% at 23° C.

In one or more non-limiting embodiments, the engineering thermoplastic is selected from polyester (e.g., polybutylene terephthalate (PBT), polyethylene terephthalate (PET), dimethyl terephthalate (DMT)), polyamide, polycarbonate, acrylonitrile butadiene styrene (ABS), copolymers thereof, or blends thereof. In one or more preferred embodiments, the engineering thermoplastic is PBT, and specific examples of suitable PBT include Ultradur® B 6550 LN, Ultradur® B 6551 LNI (available from BASF SE, Ludwigshafen, Germany), CELANEX® 2001 (available from Celanese Corporation, Irving, TX), DURANEX® 201 HR (available from Polyplastics Co., Ltd., Tokyo, Japan), POCAN® B1205XHR (available from LANXESS Deutschland GmbH, Cologne, Germany), among others.

In one or more embodiments, the first layer 40 comprises the engineering thermoplastic as well one or more additives. In one or more embodiments, the additives include antioxidants, slip agents, melt strength enhancers, and hydrolysis stabilizers. Further, the additive may be a pigment or colorant, such as carbon black, which may be provided to absorb ultraviolet light for outdoor applications.

In one or more embodiments, the cable jacket 12 having the first layer 40 of engineering thermoplastic provides a cable stiffness of at least 0.1 N·m². Table 1, below, provides a comparison of materials used for a conventional cable jacket (HDPE) and a cable jacket 12 according to the present disclosure. Of the properties provided in Table 1, contraction stress was measured using dynamic mechanical analysis (DMA) from room temperature down to −40° C., determining the stress required to hold the sample against contraction. The elastic modulus is the modulus of the material for the cable jacket. The cable bending stiffness was calculated from the product of the sum of the elastic moduli of the components in the cable and the bending moment of the cable.

TABLE 1
Properties of Cable Jacket Material and Cable Made Therefrom

| | Contraction | Elastic | Cable Bending |
|---|---|---|---|
| | Stress | Modulus | Stiffness |
| Material | (MPa) | (MPa) | (N · m²) |
| HDPE¹ | 9.13 | 800 | 0.05 |
| Copolyester² | 5.36 | 1600 | 0.10 |
| Polyamide 12³ | 7.06 | 1800 | 0.11 |
| PBT1⁴ | 13.57 | 2300 | 0.14 |

¹DGDA-6321 BK (The Dow Chemical Company, Midland, MI)
²Tritan ® TX-3001 (Eastman Chemical Company, Longview, TX)
³GRILAMID ® L 20 G POLYAMID 12 (EMS-GRIVORY, Switzerland)
⁴Ultradur ® B 6550 LN (BASF SE, Ludwigshafen, Germany)

As can be seen from Table 1, the conventional HDPE jacket material does not provide sufficient bending stiffness for cable blowing or jetting applications. Further, the elastic modulus is only about 800 MPa, and the contraction stress is over 9 MPa. The engineering plastics of copolyester, polyamide 12 have elastic moduli at least twice as high as HDPE, but the contraction stress is lower for each, in particular half as much as HDPE for the copolyester.

In one or more embodiments, the cable jacket 12 further includes a skin layer 42. The engineering plastics used in the first layer 40 have enhanced mechanical properties, but these polymers may also be susceptible to environmental degradation or may not possess certain other desired properties for the outer surface 16 of the optical fiber cable 10. In such embodiments, the first layer 40 may be surrounded with a skin layer 42. For example, the skin layer 42 may provide UV, chemical, and/or hydrolysis protection and may reduce friction at the outer surface 16, which can enhance blowing or jetting performance. In one or more embodiments, the skin layer 42 has a thickness of five micrometers to a few hundreds of micrometers (e.g., 5 μm to 500 μm). In one or more embodiments, the skin layer 42 comprises high density polyethylene (HDPE) or medium density polyethylene (MDPE).

In embodiments in which a skin layer 42 is included, the first layer 40 of engineering plastic may optionally include a compatibilizer to improve bonding between the first layer 40 and the skin layer 42. For example, for a skin layer 42 of HDPE or MDPE, a first layer 40 of PBT may include such compatibilizers as reactive ethylene, butyl acrylate, and glycidyl methacrylate terpolymer (e.g., Lotader® AX series, available from Arkema Functional Polyolefins, Colombes Cedex, France) or maleic anhydride (MAH) containing compositions.

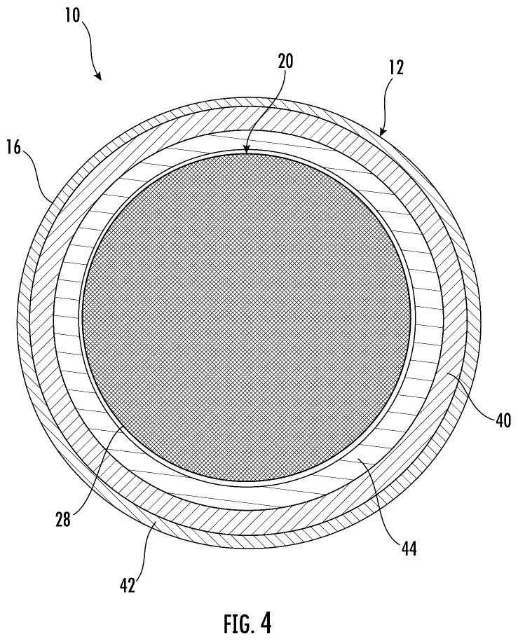

FIG. 4 depicts another concept for a cable jacket design that improves bending stiffness and enhances anti-buckling performance at low temperatures. In one or more embodiments, including the embodiment shown in FIG. 4, the cable jacket 12 includes a first layer 40 of engineering plastics around a second layer 44 of a thermoplastic elastomer. In this way, a softer inner layer is surrounded by a harder outer layer. In this way, the cable jacket 12 has a high modulus component to enhance bending stiffness and a low modulus component to address buckling and contraction stress at low temperature.

In one or more embodiments, the thermoplastic elastomer of the second layer 44 has an elastic modulus of at most 10 MPa. In one or more embodiments, the thermoplastic elastomer of the second layer 44 has an elastic modulus of at least 5 MPa. In one or more embodiments, the thermoplastic elastomer has a strain at break of at least 200% at 23° C., in particular at least 400% at 23° C. In one or more embodiments, the thermoplastic elastomer has a glass transition temperature of less than −30° C., in particular less than −40° C.

In one or more embodiments, the thermoplastic elastomer is selected from olefin block copolymers (e.g., Infuse® available from The Dow Chemical Company, Midland, MI), olefin random copolymers (e.g., Engage® available from The Dow Chemical Company, Midland, MI), ethylene-propylene rubber (EPR), ethylene-propylene-diene rubber (EPRM), ethylene-octene (EO), ethylene-hexene (EH), ethylene-butene (EB), ethylene-vinyl acetate (EVA), polyester elastomer (e.g., Hytrel available from Celanese Corporation, Irving, TX), polyamide elastomer, thermoplastic polyurethane, styrene-ethylene-butadiene-styrene (SEBS), and combinations thereof.

In one or more embodiments, the ratio of thickness of the second layer 44 to the first layer 42 is at most 1:1, and preferably at most 0.5:1.

Table 3 provides material properties and cable performance properties for a cable jacket having a conventional HDPE jacket, for a jacket with a single layer of engineering plastic as shown in FIG. 3, and for a dual layer jacket as shown in FIG. 4. The contraction stress was measured using DMA as described above. The elastic modulus pertains to a particular material of the cable jacket 12 (first layer 40 or second layer 44), and the bending stiffness relates to the cable jacket design (single layer or dual layer).

TABLE 2
Properties of Cable Jacket Layer and Cable Made Therefrom

| | Contraction | Elastic | Cable Bending |
|---|---|---|---|
| | Stress | Modulus | Stiffness |
| Material | (MPa) | (MPa) | (N · m²) |
| HDPE¹ | 9.13 | 800 | 0.05 |
| OBC1² | 0.425 | 1.2 | — |
| OBC2³ | 0.066 | 1.3 | 0.12⁴ |
| Polyamide 12⁵ | 7.06 | 1800 | 0.11 |
| PBT1⁶ | 13.57 | 2300 | 0.14 |

¹DGDA-6321 BK
²Infuse 9100 TPE (The Dow Chemical Company, Midland, MI)
³Infuse 9077 TPE (The Dow Chemical Company, Midland, MI)
⁴bending stiffness calculated based on 0.2 μm thick second layer 44 with first layer 42 of PBT (Ultradur ® B 6550 LN)
⁵GRILAMID ® L 20 G POLYAMID 12 (EMS-GRIVORY, Switzerland)
⁶Utradur ® B 6550 (BASF SE, Ludwigshafen, Germany)

As can be seen from Table 2, the OBC2 thermoplastic elastomer had an extremely low contraction stress compared to the conventional HDPE and to the engineering thermoplastics. Further, when the thermoplastic elastomer second layer 44 is incorporated into the structure of a cable jacket 12 with the first layer 42, the bending stiffness of the cable is maintained well above an HDPE cable jacket and also above the desired level of 0.1 N·m² for blowing and jetting applications.

As with the previous embodiment, the dual layer cable jacket 12 can also include a skin layer 12 as described above. In one or more such embodiments, the first layer 40 of the engineering thermoplastic may be provided with a compatibilizer as described above.

According to another concept based on the dual layer cable jacket 12, the second layer 44 of thermoplastic elastomer is foamed. In one or more embodiments, the second layer 44 is foamed via physical foaming or via chemical foaming during an extrusion process. Advantageously, foaming the second layer provides additional cushion to the cable core 20. In particular, the foamed second layer 44 provides additional space to deflect excessive loads during bending, twisting, coiling, and crushing of the cable core 20.

In one or more embodiments, the second layer 44 can be foamed to provide a 10% to 60% density reduction (i.e., the foamed material has a density that is 40% to 90% of the density of the unfoamed material). In one or more embodiments, the foamed second layer 44 has a closed cell morphology, which provides water blocking around the cable core 20. In one or more embodiments, the foamed second layer 44 has voids with an average void size of 20 μm to 100 μm, in particular 20 μm to 50 μm.

As with the previous concepts, the dual layer jacket 12 with a foamed second layer 44 may also include a skin layer 42.

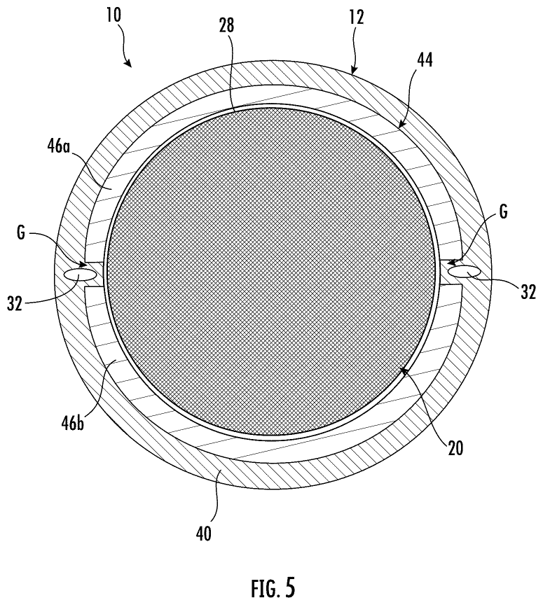

FIG. 5 depicts another concept for the cable jacket design that increases the bending stiffness and improves anti-buckling performance at low temperatures. As shown in FIG. 5, the cable jacket 12 includes a first layer 40 that is an outer layer of the cable jacket 12 and a second layer 44 that is an inner layer of the cable jacket 12. The second layer 44 is divided into a first section 46a and a second section 46b. Each end of the first section 46a is separated from a respective end of the second section 46b by a gap G. As can be seen, the material of the first layer 40 fills the gaps G between the first section 46a and the second section 46b of the second layer 44. Thus, the second layer 44 may be described as forming a discontinuous layer around the cable core 20. In one or more embodiments, including the embodiment shown in FIG. 5, an access feature 32 can also be provided in each gap G between the first section 46a and the second section 46b. In one or more embodiments, the combined span of the gaps G is 25% or less, 15% or less, or 10% or less of the circumference of the second layer 44.

In one or more embodiments, the second layer 44 comprises an engineering thermoplastic as opposed to the other dual layer jackets where the inner second layer 44 comprises a foamed or unfoamed a thermoplastic elastomer. In one or more embodiments, the outer first layer 40 comprises a polyethylene (e.g., HDPE or MDPE). In one or more embodiments, the first and second sections 46a, 46b of the second layer 44 make up at least 50% of the cross-sectional area of the cable jacket 12. In this way, the first layer 40 acts similarly to the skin layer 42 of the previously described embodiments.

In one or more embodiments, the second layer 44 comprises a halogen-free engineering thermoplastic with a flame retardant additive. In one or more embodiments, the first layer 40 comprises a flame retardant polymer, such as a low smoke, zero halogen flame retardant composition.

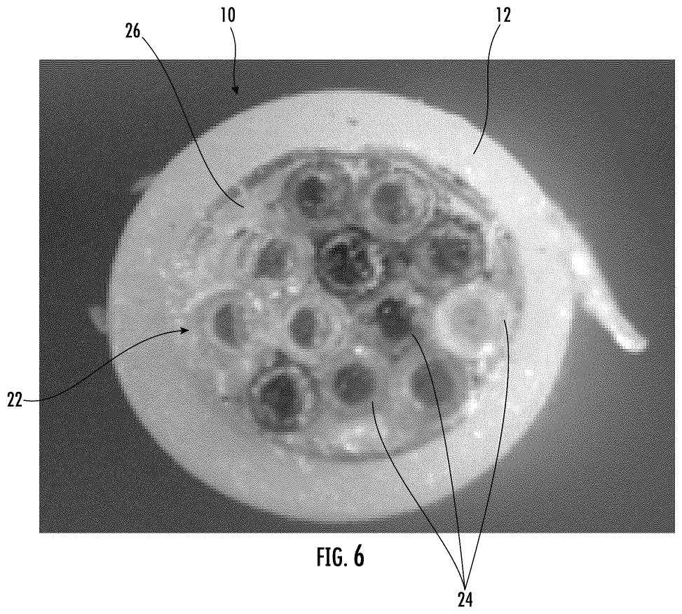

In order to determine the low temperature performance of the optical fiber cable as described in the foregoing embodiments, a sample optical fiber cable was prepared as shown in FIG. 6. The sample optical fiber cable 10 included a single lumen 22 having twelve optical fibers 24 disposed within a membrane 26. A cable jacket 12 was extruded around the single lumen 22. Two cable jackets 12 having two different PBT types were extruded around the lumen 22, and the optical fiber cable 10 samples were subjected to thermal cycling testing (TCT).

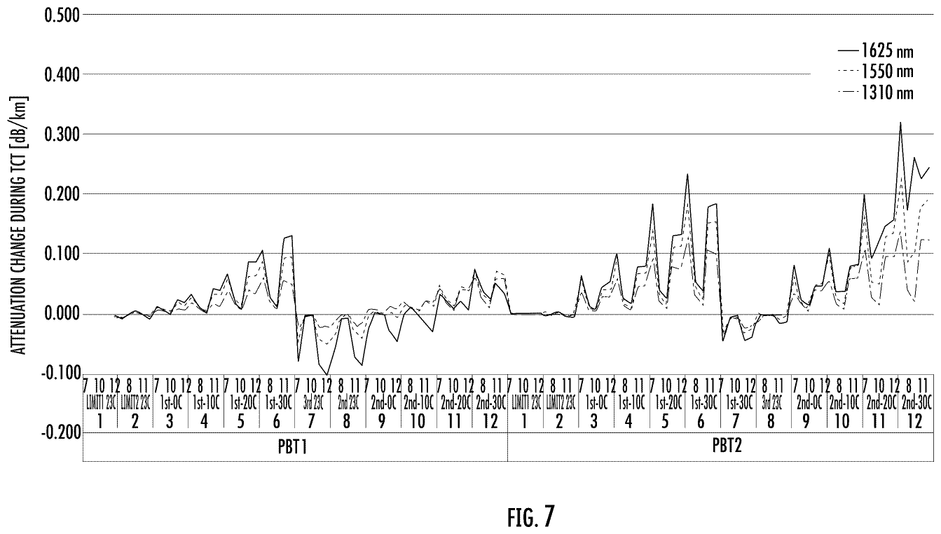

FIG. 7 depicts the results of the TCT. As can be seen in FIG. 7, TCT involves subjecting the optical fiber cable 10 to a decrease in temperature starting from room temperature to −30° C., and then the temperature is raised to 70° C. Thereafter, the temperature is decreased to room temperature again and decreased to −30° C. a second time. As can be seen, the optical fiber cable 10 experienced a change in attenuation of less than 0.15 dB/km throughout the thermal cycling at a wavelength of 1310 nm. For the higher wavelengths of 1550 nm and 1625 nm, the change in attenuation substantially remained below 0.3 dB/km.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
a cable jacket comprising an inner surface and an outer surface, the inner surface defining a central bore and the outer surface defining an outermost surface of the optical fiber cable; and
a cable core disposed in the central bore, the cable core comprising a plurality of optical fibers;
wherein the optical fiber cable comprises a cross-sectional area as defined by the outer surface of the cable jacket;
wherein the plurality of optical fibers divided by the cross-sectional area defines a fiber density of at least 7.5 fibers/mm²; and
wherein the cable jacket comprises a first layer, the first layer comprising an engineering thermoplastic having an elastic modulus of at least 800 MPa.

2. The optical fiber cable of claim 1, wherein the engineering thermoplastic is selected from a group consisting of polyester, polyamide, polycarbonate, acrylonitrile butadiene styrene (ABS), copolymers thereof, or blends thereof.

3. The optical fiber cable of claim 1, wherein the engineering thermoplastic further comprises an averaged coefficient of thermal expansion as measured between −40° C. and 25° C. of at most 150 ppm/° C.

4. The optical fiber cable of claim 1, wherein the optical fiber cable comprises a bending stiffness of at least 0.1 N·m².

5. The optical fiber cable of claim 1, wherein the cable jacket further comprises a skin layer having a thickness in a range from 5 μm to 500 μm disposed around the first layer, the skin layer defining the outer surface of the cable jacket.

6. The optical fiber cable of claim 5, wherein the first layer further comprises a compatibilizer configured to enhance bonding between the engineering thermoplastic of the first layer and the skin layer.

7. The optical fiber cable of claim 1, wherein the cable jacket further comprises a second layer, the second layer comprising a thermoplastic elastomer and the second layer defining the inner surface of the cable jacket, and wherein the first layer surrounds the second layer.

8. The optical fiber cable of claim 7, wherein the thermoplastic elastomer is selected from a group consisting of olefin block copolymers, olefin random copolymers, ethylene-propylene rubber (EPR), ethylene-propylene-diene rubber (EPRM), ethylene-octene (EO), ethylene-hexene (EH), ethylene-butene (EB), ethylene-vinyl acetate (EVA), polyester elastomer, polyamide elastomer, thermoplastic polyurethane, styrene-ethylene-butadiene-styrene (SEBS), and combinations thereof.

9. The optical fiber cable of claim 7, wherein the first layer comprises a first thickness and the second layer comprises a second thickness and wherein a ratio of the second thickness to the first thickness is 1:1 or less.

10. The optical fiber cable of claim 7, the thermoplastic elastomer of the second layer is a foamed thermoplastic elastomer having a foam density that is 40% to 90% of a density of the thermoplastic elastomer.

11. The optical fiber cable of claim 10, wherein the foamed thermoplastic elastomer has a closed cell morphology and the foamed thermoplastic elastomer comprising voids having an average void size of 20 μm to 100 μm.

12. The optical fiber cable of claim 7, wherein the cable jacket further comprises a skin layer having a thickness in a range from 5 μm to 500 μm disposed around the first layer, the skin layer defining the outer surface of the cable jacket.

13. The optical fiber cable of claim 1, wherein the first layer is discontinuous and comprises a first section and a second section, the first section being separated from the second section by a gap, and wherein the cable jacket comprises a second layer that surrounds the first layer and fills the gap between the first section and the second section.

14. The optical fiber cable of claim 13, wherein the engineering thermoplastic of the first layer is halogen-free and wherein a flame retardant additive is dispersed in the engineering thermoplastic.

15. The optical fiber cable of claim 13, wherein the second layer comprises a low smoke, zero halogen polymer composition.

16. The optical fiber cable of claim 1, wherein the plurality of optical fibers of the cable core are arranged into a plurality of lumens, each lumen of the plurality of lumens comprising at least two optical fibers surrounded by a membrane.

17. The optical fiber cable of claim 1, wherein the plurality of optical fibers of the cable core are arranged into a plurality of intermittently bonded ribbons.

18. An optical fiber cable, comprising:
a cable jacket comprising an inner surface and an outer surface, the inner surface defining a central bore and the outer surface defining an outermost surface of the optical fiber cable; and
a cable core disposed in the central bore, the cable core comprising a plurality of optical fibers;
wherein the optical fiber cable has a cumulative fiber filling coefficient of at least 50%; and
wherein the cable jacket comprises at least two layers, the at least two layers being selected from a group consisting of a skin layer, an engineering thermoplastic layer, and a thermoplastic elastomer layer.

19. The optical fiber cable of claim 18, wherein the cable jacket comprises the skin layer and the engineering thermoplastic layer, the skin layer surrounding the engineering thermoplastic layer and the skin layer defining the outer surface of the cable jacket.

20. The optical fiber cable of claim 19, wherein the cable jacket further comprises the thermoplastic elastomer layer, the thermoplastic elastomer layer defining the inner surface of the cable jacket.
